(19) United States
(12) Patent Application Publication
(10) Pub. No.: US 2021/0368869 A1
(43) Pub. Date: Dec. 2, 2021

(54) CONTROL CIRCUIT MODULE PACKAGE OF ELECTRONIC CIGARETTE

(71) Applicant: ITM SEMICONDUCTOR CO., LTD., Cheongju-si (KR)

(72) Inventors: Hyuk Hwi NA, Cheongju-si (KR); Ho Seok HWANG, Gunpo-si (KR); Ja Guen GU, Cheongju-si (KR); Chi Sun SONG, Cheongju-si (KR); Seong Beom PARK, Cheongju-si (KR); Sun Ho KIM, Osan-si (KR)

(21) Appl. No.: 17/326,755

(22) Filed: May 21, 2021

(30) Foreign Application Priority Data
Jun. 2, 2020 (KR) 10-2020-0066505
Jun. 2, 2020 (KR) 10-2020-0066506
Jun. 3, 2020 (KR) 10-2020-0067232

(51) Int. Cl. A24F 40/90; A24F 40/57; A24F 40/51; A24F 40/60; A24F 40/65

(52) U.S. Cl. CPC A24F 40/90; A24F 40/57; H02J 7/00302; A24F 40/60; A24F 40/65; A24F 40/51

(57) ABSTRACT

A control circuit module package of an electronic cigarette according to an aspect of the present invention includes a package substrate, a plurality of control circuit elements mounted on the package substrate for controlling operations of the electronic cigarette and controlling charging of a battery inside the electronic cigarette, and a molding part that integrally encapsulates the plurality of control circuit elements.

### CROSS-REFERENCE TO RELATED APPLICATION

This application claims priority on Korean Patent Application Nos. 10-2020-0066505 and 10-2020-0066506, both filed on Jun. 2, 2020, and Korean Patent Application No. 10-2020-0067232, filed on Jun. 3, 2020, the contents of which are incorporated herein by reference.

### BACKGROUND OF THE INVENTION

### Field of the Invention

The present invention relates to an electronic cigarette, and more specifically, to a control circuit module package of the electronic cigarette.

### Description of Related Art

An electronic cigarette may indicate an electronic device that generates fumes by electrically heating a solution containing nicotine or a solid tobacco using a built-in battery. In such an electronic cigarette, various control circuits, such as a circuit for charging a built-in battery, a circuit for controlling a heat generation device, and a main control circuit, are individually mounted on a printed circuit board.

Due to recent reduction in size and weight of an electronic cigarette, an overall product volume thereof is reduced, and thus a design space for each component has been reduced. However, due to an increasing demand for multifunctionalization of products, control circuits are gradually increasing. In addition, although a demand for increasing a battery capacity of an electronic cigarette is increasing, there is a limit to increasing the battery capacity due to the reduction in product size.

Further, in the case of a liquid electronic cigarette, leakage of a liquid damages a control circuit, which results in increased circuit failures, and thus costs for customer services increase and product reliability deteriorates.

### PATENT DOCUMENTS

[Patent Document 1] Korean Patent Application Publication No. 10-2013-0122713 (published on Nov. 8, 2013)

### SUMMARY OF THE INVENTION

An object of the present invention is to provide a method of garbling a real-world image for a see-through head mounted display and a direct encoding type see-through head mounted display, which is distinguished from existing augmented reality techniques for matching virtual information to a real-world image and is distinguished from correction techniques for improving image quality of a see-through image.

Thus, the present invention is to solve the above-described problems, and an object of the present invention is to provide a control circuit module package of an electronic cigarette that can be reduced in size to have a large margin for a design space and has high reliability. However, these problems are exemplary, and the scope of the present invention is not limited thereto.

A control circuit module package of an electronic cigarette according to an aspect of the present invention includes a package substrate, a plurality of control circuit elements mounted on the package substrate for controlling operations of the electronic cigarette and controlling charging of a battery inside the electronic cigarette, and a molding part that integrally encapsulates the plurality of control circuit elements.

According to the control circuit module package of an electronic cigarette, the plurality of control circuit elements may include a plurality of active elements, and the plurality of active elements may be integrally encapsulated on the package substrate by the molding part.

According to the control circuit module package of an electronic cigarette, the plurality of control circuit elements may further include a plurality of passive elements, and the plurality of active elements and the plurality of passive elements may be integrally encapsulated on the package substrate by the molding part.

According to the control circuit module package of an electronic cigarette, at least one element of the plurality of control circuit elements may be mounted on the package substrate at a wafer die level and encapsulated by the molding part.

According to the control circuit module package of an electronic cigarette, all of the plurality of active elements may be mounted on the package substrate at the wafer die level and encapsulated by the molding part.

According to the control circuit module package of an electronic cigarette, at least another one of the plurality of active elements may be mounted on the package substrate in a state in which it is separately molded in advance.

According to the control circuit module package of an electronic cigarette, a height of the molding part may vary in accordance with heights of the plurality of control circuit elements.

According to the control circuit module package of an electronic cigarette, the plurality of active elements may include at least two or more of a main control unit, at least one heat generation control circuit, at least one motor control circuit, at least one sensor control circuit, at least one switch control circuit, at least one display device control circuit, at least one Bluetooth control circuit, at least one charging control circuit, and at least one battery protection circuit.

According to the control circuit module package of an electronic cigarette, the plurality of active elements may include all of a main control unit, at least one heat generation control circuit, at least one motor control circuit, at least one sensor control circuit, at least one switch control circuit, at least one display device control circuit, at least one Bluetooth control circuit, at least one charging control circuit, and at least one battery protection circuit.

According to the control circuit module package of an electronic cigarette, the plurality of control circuit elements may further include a plurality of passive elements, and the plurality of passive elements may be exposed from the molding part.

According to the control circuit module package of an electronic cigarette, the package substrate may include any one of a printed circuit board and a lead frame, or a stacked structure thereof.

The control circuit module package of an electronic cigarette may further include a heat generation device connected to one end of the package substrate.

A control circuit module assembly of an electronic cigarette according to another aspect of the present invention includes a first control circuit module package of the electronic cigarette, a second control circuit module package of the electronic cigarette, and a connection line that electrically connects the first control circuit module package with the second control circuit module package, in which the first control circuit module package includes first control circuit elements among a plurality of control circuit elements for controlling operations of the electronic cigarette and controlling charging of a battery, and the second control circuit module package includes second control circuit elements among the plurality of control circuit elements for controlling the operations of the electronic cigarette and controlling the charging of the battery.

According to the control circuit module assembly of an electronic cigarette, the first control circuit elements may include elements for controlling the charging of the battery of the electronic cigarette among the plurality of control circuit elements, and the second control circuit elements may include elements for controlling the operations of the electronic cigarette among the plurality of control circuit elements.

According to the control circuit module assembly of an electronic cigarette, the connection line may include a flexible printed circuit board (FPCB), and a length of the connection line may correspond to a length of a main case so that the first control circuit module package and the second control circuit module package are respectively located at both ends of the main case when they are accommodated in the main case of the electronic cigarette.

The control circuit module assembly of an electronic cigarette may further include a third control circuit module package of the electronic cigarette connected to the first control circuit module package, and a fourth control circuit module package of the electronic cigarette connected to the second control circuit module package, the third control circuit module package may include third control circuit elements among the plurality of control circuit elements for controlling the operations of the electronic cigarette and controlling the charging of the battery, and the fourth control circuit module package may include fourth control circuit elements among the plurality of control circuit elements for controlling the operations of the electronic cigarette and controlling the charging of the battery.

A control circuit module package for an electronic cigarette cradle according to yet another aspect of the present invention includes a package substrate, a plurality of control circuit elements mounted on the package substrate for controlling charging of the electronic cigarette when the electronic cigarette is connected, and a molding part that integrally encapsulates the plurality of control circuit elements.

According to the control circuit module package for an electronic cigarette cradle, the plurality of control circuit elements may include a plurality of active elements, and the plurality of active elements may be integrally encapsulated on the package substrate by the molding part.

According to the control circuit module package for an electronic cigarette cradle, at least one element of the plurality of control circuit elements may be mounted on the package substrate at a wafer die level and encapsulated by the molding part.

According to the control circuit module package for an electronic cigarette cradle, a height of the molding part may vary in accordance with heights of the plurality of control circuit elements.

According to some embodiments of the present invention configured as described above, a control circuit module package of an electronic cigarette that can be reduced in size to increase a margin for a design space of the electronic cigarette and has high protection against external conditions may be provided. Of course, the scope of the present invention is not limited by these effects.

### BRIEF DESCRIPTION OF THE DRAWINGS

FIG. 1 is a cross-sectional view schematically showing a control circuit module package of an electronic cigarette according to an embodiment of the present invention.

FIG. 2 is a cross-sectional view schematically showing a control circuit module package of an electronic cigarette according to another embodiment of the present invention.

FIG. 3 is a cross-sectional view schematically showing a control circuit module package of an electronic cigarette according to yet another embodiment of the present invention.

FIG. 4 is a block diagram showing a configuration of control circuit elements in the control circuit module package and a configuration of the electronic cigarette including the same according to embodiments of the present invention.

FIG. 5 is a plan view schematically showing a control circuit module package of an electronic cigarette according to still another embodiment of the present invention.

FIG. 6 is a perspective view schematically showing a control circuit module assembly of an electronic cigarette according to an embodiment of the present invention.

FIG. 7 is a perspective view schematically showing a control circuit module assembly of an electronic cigarette according to another embodiment of the present invention.

FIG. 8 is a cross-sectional view schematically showing a first control circuit module package in the control circuit module assembly of the electronic cigarette according to embodiments of the present invention.

FIG. 9 is a cross-sectional view schematically showing a modified example of the first control circuit module package of FIG. 8.

FIG. 10 is a cross-sectional view schematically showing a second control circuit module package in the control circuit module assembly of the electronic cigarette according to embodiments of the present invention.

FIG. 11 is a cross-sectional view schematically showing a modified example of the second control circuit module package of FIG. 10.

FIG. 12 is a perspective view schematically showing a configuration of the electronic cigarette using the control circuit module assembly of FIG. 6.

FIG. 13 is a perspective view schematically showing a configuration of the electronic cigarette using the control circuit module assembly of FIG. 7.

FIG. 14 is a cross-sectional view schematically showing a control circuit module package for an electronic cigarette cradle according to an embodiment of the present invention.

FIG. 15 is a cross-sectional view schematically showing a control circuit module package for an electronic cigarette cradle according to another embodiment of the present invention.

FIG. 16 is a cross-sectional view schematically showing a control circuit module package for an electronic cigarette cradle according to yet another embodiment of the present invention.

FIG. 17 is a block diagram showing a configuration of control circuit elements in the control circuit module package and a configuration of the electronic cigarette cradle including the same according to embodiments of the present invention.

### DETAILED DESCRIPTION OF THE INVENTION

Hereinafter, various preferred embodiments of the present invention will be described in detail with reference to the accompanying drawings.

It should be understood that embodiments of the present invention are provided to explain the present invention more completely to those having ordinary knowledge in the art, and the following embodiments may be modified in various different forms and the scope of the present invention is not limited to the following embodiments. Rather, these embodiments are provided to make the present disclosure more sufficient and complete and to completely convey the spirit of the present invention to those skilled in the art. In addition, in the drawings, the thickness or size of each layer is exaggerated for convenience and clarity of description.

Throughout the specification, in a case in which one constituent element such as a film, a region or a substrate is described to be located “on,” “connected to,” “stacked on,” or “coupled to” another constituent element, it can be construed that the one constituent element is directly “on,” “connected to,” “stacked on,” or “coupled to” another constituent element to be joined, or that other constituent elements intervening therebetween may be present. On the other hand, in a case in which one constituent element is described to be located “directly on,” “directly connected to,” or “directly coupled to” another constituent element, it is construed that there are no other constituent elements intervening therebetween. The same reference signs indicate the same elements. As used herein, the term “and/or” includes any and all combinations of one or more of the listed items.

In the present specification, terms such as first, second, and the like are used to describe various members, components, regions, layers and/or portions, and it is obvious that these members, components, regions, layers and/or portions should not be limited by these terms. These terms are only used to distinguish one member, component, region, layer or portion from another region, layer or portion. Accordingly, a first member, component, region, layer or portion, which will be described below, can be understood with reference to a second member, component, region, layer or portion without departing from the teachings of the present invention.

The terms used in the present specification are used to describe specific embodiments and are not intended to limit the present invention. As used herein, a singular form may include a plural form unless otherwise specified clearly in the context. Also, as used herein, “comprise” and/or “comprising” is to specify the presence of mentioned shapes, numbers, steps, actions, members, elements, and/or groups thereof and does not exclude the presence or addition of one or more other shapes, numbers, actions, members, elements and/or groups.

Hereinafter, embodiments of the present invention will be described with reference to the drawings schematically showing ideal embodiments of the present invention. In the drawings, for example, depending on manufacturing techniques and/or tolerances, variations of the illustrated shapes can be expected. Accordingly, embodiments of the spirit of the present invention should not be construed as being limited to a specific shape of a region illustrated in the present specification and should include, for example, changes in shape caused by manufacturing.

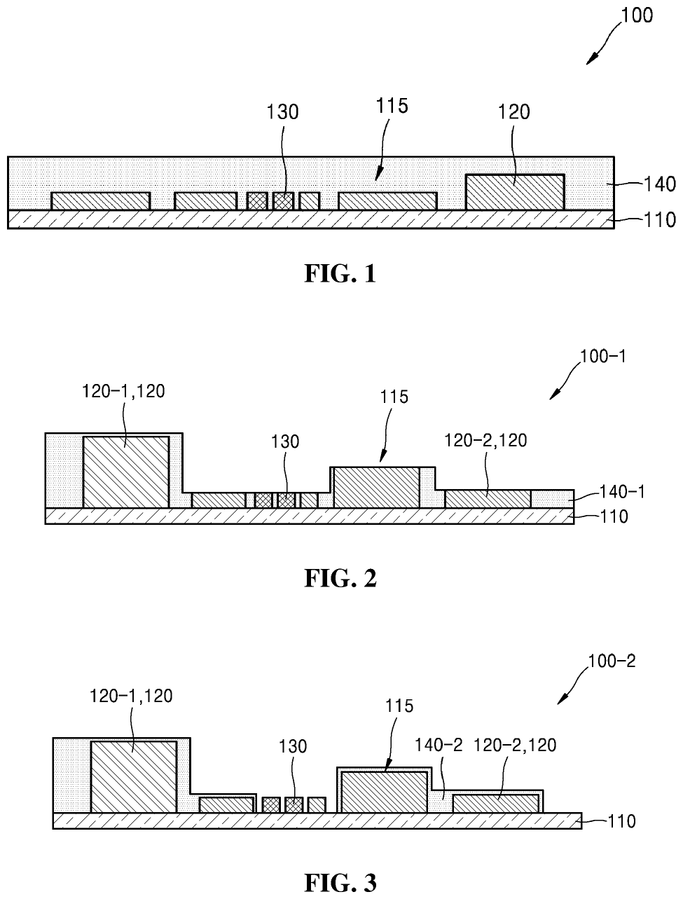

FIG. 1 is a cross-sectional view schematically showing a control circuit module package 100 of an electronic cigarette according to an embodiment of the present invention.

Referring to FIG. 1, the control circuit module package 100 of an electronic cigarette may include a package substrate 110, a plurality of control circuit elements 115, and a molding part 140.

The package substrate 110 may indicate a substrate for mounting and packaging components. For example, the package substrate 110 may include any one of a printed circuit board (PCB) and a lead frame, or a stacked structure thereof. The lead frame may be patterned to form circuit wiring in consideration of electrical connections of mounted components.

For example, the package substrate 110 may use a lead frame or a printed circuit board alone, or a structure in which a printed circuit board is stacked on a lead frame. When a lead frame made of metal is used as the package substrate 110, it may be advantageous in terms of heat dissipation. In this case, since the package substrate 110 can function as a heat dissipation pad, an improved heat dissipation effect can be obtained as compared to the case of using a printed circuit board.

The control circuit elements 115 can be mounted on the package substrate 110 and used for controlling operations of the electronic cigarette and controlling charging of a battery inside the electronic cigarette. For example, the control circuit elements 115 may include a plurality of active elements 120 and a plurality of passive elements 130.

For example, some or all of the control circuit elements 115 may be mounted on the package substrate 110 using surface mounting technology (SMT). The surface mounting technology (SMT) may indicate a technology for attaching components to a surface of the package substrate 110. For example, some or all of the control circuit elements 115 may be attached on the surface of the package substrate 110 using a soldering technique.

The molding part 140 may integrally encapsulate the control circuit elements 115. For example, the active elements 120 and the passive elements 130 constituting the control circuit elements 115 may be integrally encapsulated. For example, the molding part 140 may include an epoxy molding compound (EMC).

In this way, by integrally encapsulating the control circuit elements 115 with the molding part 140, it is possible to greatly reduce a volume of the control circuit module package 100 as compared to the case of molding or packaging the control circuit elements 115 individually.

Further, since the control circuit elements 115 are encapsulated by the molding part 140, the control circuit elements 115 can be effectively protected from moisture or the like around them. For example, in the case of a liquid electronic cigarette, a liquid flows into the control circuit elements 115 to cause problems such as corrosion or disconnection, and the occurrence of such a problem may be prevented by the molding part 140.

At least one of the control circuit elements 115 may be mounted on the package substrate 110 at a wafer die level and encapsulated by the molding part 140. The fact of being mounted on the package substrate 110 at the wafer die level may mean that an element is mounted on the package substrate 110 in a wafer die state without undergoing a separate molding or packaging process at the wafer die level.

Accordingly, since an element mounted at a wafer die level has a very thin thickness, a thickness of the molding part 140 can be made thinner, which can contribute to reducing the volume of the control circuit module package 100 as a whole.

Further, some of the control circuit elements 115 may be mounted on the package substrate 110 in a stacked structure in which they are stacked at the wafer die level.

For example, after at least one of the active elements 120 is mounted on the package substrate 110 at the wafer die level, it may be encapsulated by the molding part 140. In some embodiments, by mounting all of the active elements 120 on the package substrate 110 at the wafer die level, the volume of the control circuit module package 100 can be reduced.

According to the control circuit module package 100 described above, it is possible to reduce the overall volume of the package by integrally encapsulating at least some or all of the control circuit elements 115 with the molding part 140. Further, by mounting at least some of the control circuit elements 115 on the package substrate 110 at the wafer die level, the volume of the package can be further reduced.

In this way, when the volume of the control circuit module package 100 is reduced, a volume and a weight of the electronic cigarette using the same can be reduced, so that reduction in size and weight of the electronic cigarette becomes possible, and furthermore, space utilization can be improved by securing a design margin. For example, by reducing the volume of the control circuit module package 100, a partial space thereof can be used to increase a battery capacity of the electronic cigarette, and elements that can realize additional functions may be further added.

Also, when a lead frame is used as the package substrate 110, it can function as a heat dissipation pad, thereby enhancing a heat dissipation effect, and the charging efficiency of the battery can also be improved.

In addition, the control circuit elements 115 are encapsulated by the molding part 140, so that occurrence of a problem due to leakage or the like can be prevented, and thus protection and reliability of the electronic cigarette against surrounding conditions can be improved.

FIG. 2 is a cross-sectional view schematically showing a control circuit module package 100-1 of an electronic cigarette according to another embodiment of the present invention. The control circuit module package 100-1 according to this embodiment is a modified one of the control circuit module package 100 of FIG. 1, and thus the same description will be omitted.

Referring to FIG. 2, at least some of the control circuit elements 115 may be mounted on the package substrate 110 in a state in which they are separately molded in advance.

For example, at least one active element 120-1 of the active elements 120 may be mounted on the package substrate 110 in a state in which it is separately molded in advance, and most of the other active elements 120-2 may be mounted on the package substrate 110 in an unpackaged state, for example, at the wafer die level.

According to this structure, although a volume of the molding part 140 may be slightly increased due to a pre-molding volume of the active element 120-1, most of the active elements 120-2 are mounted on the package substrate 110 in a state in which they has not yet been molded, and thus the volume of the control circuit module package 100-1 can be kept still smaller than conventional ones.

The molding part 140 may integrally encapsulate the control circuit elements 115, for example, the active elements 120 and the passive elements 130. Accordingly, both the active element 120-1 mounted and molded in advance and the active elements 120-2 mounted at the wafer die level may be integrally encapsulated by the molding part 140.

Additionally, a height of the molding part 140 may vary in accordance with heights of the control circuit elements 115. In this case, by reducing the volume occupied by the molding part 140, the volume of the control circuit module package 100-1 can be further increased.

This structure can further increase the design margin of the electronic cigarette using the control circuit module package 100-1. For example, in the electronic cigarette, other components may be further disposed at a portion of the control circuit module package 100a100-1 at which the height of the molding part 140 is low, thereby improving space utilization.

FIG. 3 is a cross-sectional view schematically showing a control circuit module package 100-2 of an electronic cigarette according to another embodiment of the present invention. The control circuit module package 100-2 according to this embodiment is a partially modified one of the control circuit module packages 100 and 100-1 of FIGS. 1 and 2, and thus the same description will be omitted.

Referring to FIG. 3, in the control circuit module package 100-2, some or all of the passive elements 130 may be exposed from the molding part 140. In the case of the passive elements 130, they have simple structures and there is a relatively low possibility of a problem occurring even if there is moisture around them due to leakage or the like as compared to the active elements 120, and thus some or all of the passive elements 130 can also be exposed from the molding part 140.

However, even in this case, the control circuit elements 115 other than the exposed passive elements 130 may be integrally encapsulated by the molding part 140.

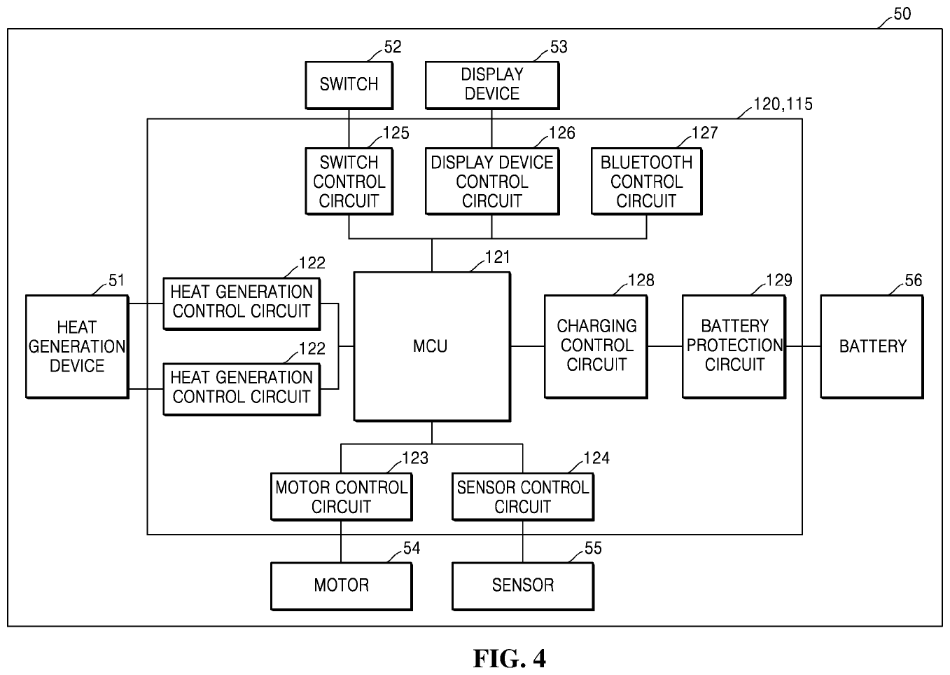

FIG. 4 is a block diagram showing a configuration of the control circuit elements 115 in the control circuit module package and a configuration of an electronic cigarette 50 including the same according to embodiments of the present invention.

Referring to FIG. 4, the electronic cigarette 50 may include the control circuit elements 115, at least one heat generation device 51, at least one switch 52, at least one display device 53, at least one motor 54, at least one sensor 55, and at least one battery 56.

The heat generation device 51 is a device for heating a liquid or solid tobacco to make fumes and may include a heating wire or a heating coil. The battery 56 may serve to supply electric power to the electronic cigarette 50 wirelessly.

In FIG. 4, the active elements 120 are shown as main components of the control circuit elements 115, and the passive elements 130 are omitted.

The active elements 120 may include at least two or more or all of a main control unit (MCU) 121, at least one heat generation control circuit 122, at least one motor control circuit 123, at least one sensor control circuit 124, at least one switch control circuit 125, at least one display device control circuit 126, at least one Bluetooth control circuit 127, at least one charging control circuit 128, and at least one battery protection circuit 129.

The main control unit 121 may be a central processing unit that controls main operations of the electronic cigarette 50. For example, the main control unit 121 may receive signals from the switch 52 and the sensor 55, control operations of the heat generation device 51, control signals displayed on the display device 53, control operations of the motor 54, and control operations of the battery 56.

The heat generation control circuit 122 may be connected between the main control unit 121 and the heat generation device 51 and control the operations of the heat generation device 51 in accordance with control of the main control unit 121. One or a plurality of heat generation control circuit 122 may be provided and a half bridge circuit or a full bridge circuit may be included therein, for example.

The motor control circuit 123 may be connected between the main control unit 121 and the motor 54 and control the operations of the motor 54 in accordance with the control of the main control unit 121. The sensor control circuit 124 may be connected between the main control unit 121 and the sensor 55, the switch control circuit 125 may be connected between the main control unit 121 and the switch 52, and the display device control circuit 126 may be connected between the main control unit 121 and the display device 53. The Bluetooth control circuit 127 may be connected to the main control unit 121 to control Bluetooth signals.

The charging control circuit 128 and the battery protection circuit 129 may be connected between the main control unit 121 and the battery 56, control the charging of the battery 56, and control the operations of the battery 56 to protect the battery 56 in situations such as overcharging, overvoltage, and overcurrent of the battery 56. For example, the battery protection circuit 129 may include a protection integrated circuit and a field effect transistor.

In the control circuit module packages 100, 100-1, and 100-2 described above, the active elements 120 may include a plurality of control circuits as described above, and these control circuits may be mounted on the package substrate 110 at the wafer die level and integrally encapsulated by the molding part 140.

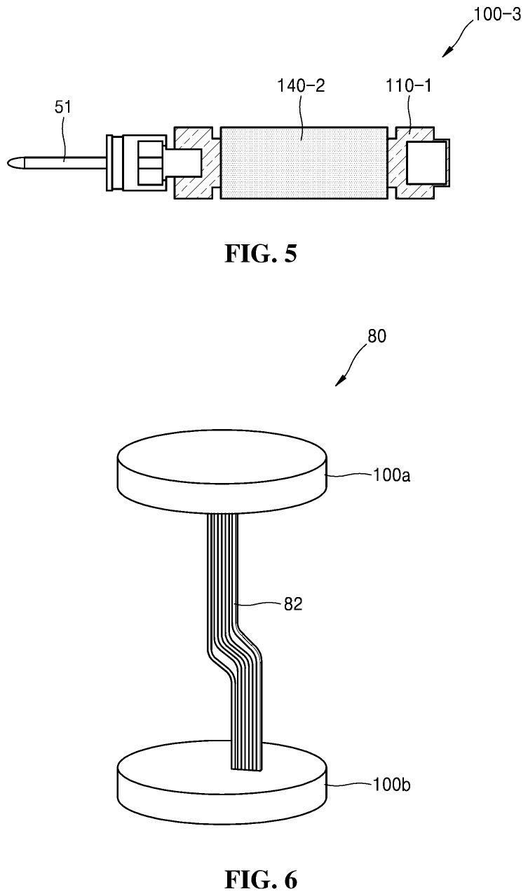

FIG. 5 is a plan view schematically showing a control circuit module package 100-3 according to still another embodiment of the present invention. The control circuit module package 100-3 according to this embodiment is a modification of some configurations of the control circuit module packages 100, 100-1 and 100-2 of FIGS. 1, 2 and 3, and thus the same description will be omitted.

Referring to FIG. 5, the control circuit module package 100-3 may have a structure in which the control circuit elements 115 are integrally encapsulated by a molding part 140-2 on a package substrate 110-1 and may further include the heat generation device 51 at one end of the package substrate 110-1. In the control circuit module package 100-3, the heat generation device 51 may be fixedly connected to one end of the package substrate 110-1.

However, depending on a structure of the electronic cigarette, as in the case of the control circuit module packages 100, 100-1, and 100-2, without directly connecting the heat generation device 51 with the package substrate 110, the package substrate 110-1 is disposed in a main body housing, the heat generation device 51 is disposed in an atomizer, and the main body housing is connected to the atomizer, so that the control circuit module packages 100, 100-1, and 100-2 are electrically connected to the heat generation device 51.

FIG. 6 is a perspective view schematically showing a control circuit module assembly 80 of an electronic cigarette according to an embodiment of the present invention.

Referring to FIG. 6, the control circuit module assembly 80 may include a first control circuit module package 100a, a second control circuit module package 100b, and a connection line 82.

The first control circuit module package 100a and the second control circuit module package 100b may include at least some of the plurality of control circuit elements (115 in FIG. 4) for controlling the operations of the electronic cigarette and controlling the charging of the battery. For example, the first control circuit module package 100a includes first control circuit elements (115a in FIG. 8) of the plurality of control circuit elements 115, and the second control circuit module package 100b may include second control circuit elements (115b of FIG. 10) of the plurality of control circuit elements 115.

The connection line 82 may electrically connect the first control circuit module package 100a with the second control circuit module package 100b. For example, the connection line 82 may include a flexible printed circuit board (FPCB).

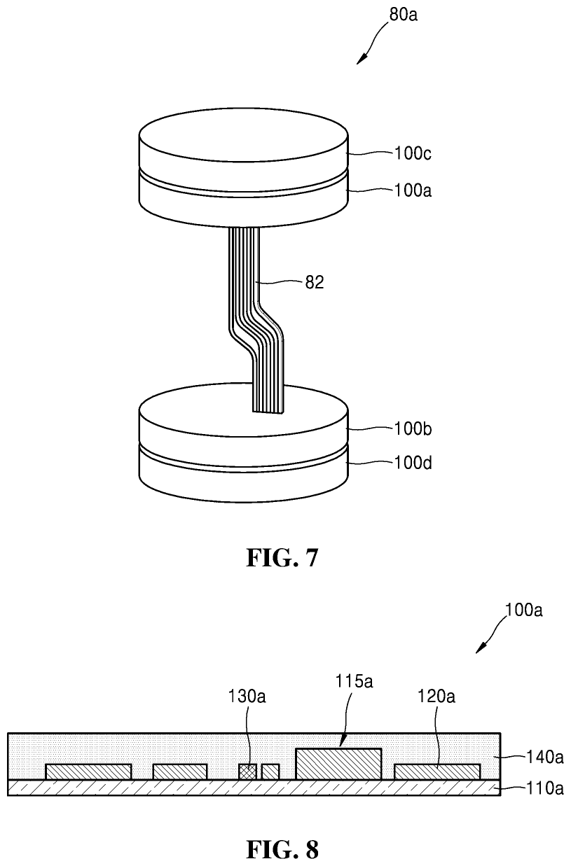

FIG. 7 is a perspective view schematically showing a control circuit module assembly 80a of an electronic cigarette according to another embodiment of the present invention. Since the control circuit module assembly 80a according to this embodiment is formed by adding some configurations to the control circuit module assembly 80 of FIG. 6 or modifying it, the same description in the embodiments will be omitted.

Referring to FIG. 7, the control circuit module assembly 80a may include the first control circuit module package 100a, the second control circuit module package 100b, a third control circuit module package 100c, a fourth control circuit module package 100d, and the connection line 82.

The first control circuit module package 100a, the second control circuit module package 100b, the third control circuit module package 100c, and the fourth control circuit module package 100d may include a plurality of control circuit elements for controlling the operations of the electronic cigarette and controlling the charging of the battery. For example, the first control circuit module package 100a, the second control circuit module package 100b, the third control circuit module package 100c, and the fourth control circuit module package 100d are electrically connected to each other via the connection line 82.

As another example, the third control circuit module package 100c may be connected to the first control circuit module package 100a, and the fourth control circuit module package 100d may be connected to the second control circuit module package 100b. More specifically, the first control circuit module package 100a and the third control circuit module package 100c may be stacked on each other and electrically connected to each other via separate wiring therebetween. The second control circuit module package 100b and the fourth control circuit module package 100d may be stacked on each other and electrically connected to each other via separate wiring therebetween.

Hereinafter, the first control circuit module package 100a and the second control circuit module package 100b will be described in more detail.

FIG. 8 is a cross-sectional view schematically showing the first control circuit module package 100a in the control circuit module assembly of an electronic cigarette according to embodiments of the present invention. The first control circuit module package 100a can be understood with reference to the control circuit module package 100 of FIG. 1, and the same description in the embodiments will be omitted.

Referring to FIG. 8, the first control circuit module package 100a may include a first package substrate 110a, first control circuit elements 115a, and a first molding part 140a. For example, the first control circuit module package 100a may have a structure in which the first control circuit elements 115a are mounted on the first package substrate 110a and at least some of the first control circuit elements 115a are integrally encapsulated by the first molding part 140a.

The first package substrate 110a, the first control circuit elements 115a, and the first molding part 140a can be understood with reference to the package substrate 110, the control circuit elements 115, and the molding part 140 of FIG. 1, respectively.

At least one of the first control circuit elements 115a may be mounted on the first package substrate 110a at the wafer die level and encapsulated by the first molding part 140a. Further, some of the first control circuit elements 115a may be mounted on the first package substrate 110a in a stacked structure stacked at the wafer die level. For example, after at least one of active elements 120a is mounted on the first package substrate 110a at the wafer die level, it may be encapsulated by the first molding part 140a.

According to the first control circuit module package 100a described above, by integrally encapsulating at least some or all of the first control circuit elements 115a with the first molding part 140a, the overall volume of the package can be reduced. Further, by mounting at least some of the first control circuit elements 115a on the first package substrate 110a at the wafer die level, the package volume cam be further reduced.

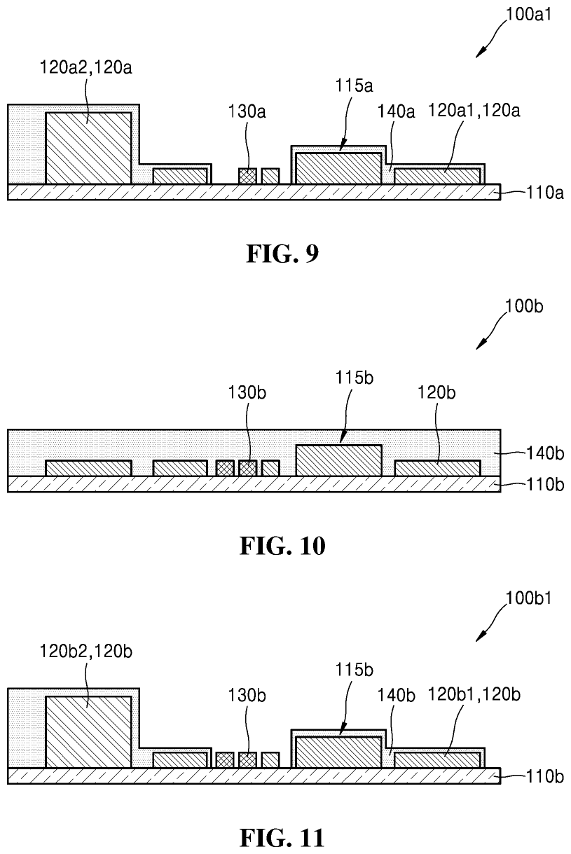

FIG. 9 is a cross-sectional view schematically showing a first control circuit module package 100a1 according to a modified example of FIG. 8. The first control circuit module package 100a1 is a modified one of the first control circuit module package 100a, and thus the same description as in the embodiments will be omitted.

Referring to FIG. 9, at least some of the first control circuit elements 115a may be mounted on the first package substrate 110a in a state in which they are separately molded in advance.

For example, at least one of the active elements 120a may be mounted on the first package substrate 110a in a state in which it is separately molded in advance, and most of the other active elements 120a1 may be mounted on the first package substrate 110a in an unpackaged state, for example, at the wafer die level.

The first molding part 140a may integrally encapsulate some of the first control circuit elements 115a, for example, the active elements 120a, and passive elements 130a may be exposed from the first molding part 140a. Accordingly, both active element 120a2 molded and mounted in advance and the active elements 120a1 mounted at the wafer die level may be integrally encapsulated by the first molding part 140a, and the passive elements 130a may not be encapsulated by the first molding part 140a.

Additionally, a height of the first molding part 140a may vary in accordance with heights of the first control circuit elements 115a. In this case, by reducing the volume occupied by the first molding part 140a, a volume of the first control circuit module package 100a1 may be further reduced. This structure can further increase a design margin of the electronic cigarette using the first control circuit module package 100al.

FIG. 10 is a cross-sectional view schematically showing the second control circuit module package 100b in the control circuit module assembly of an electronic cigarette according to embodiments of the present invention. The second control circuit module package 100b has a configuration similar to that of the first control circuit module package 100a of FIG. 8, and most configurations thereof can be understood with reference to each other.

Referring to FIG. 10, the second control circuit module package 100b may include a second package substrate 110b, the second control circuit elements 115b, and a second molding part 140b. For example, the second control circuit module package 100b may have a structure in which the second control circuit elements 115b are mounted on the second package substrate 110b and at least some of the second control circuit elements 115b are integrally encapsulated by the second molding part 140b.

The second package substrate 110b, the second control circuit elements 115b, and the second molding part 140b in the second control circuit module package 100b may correspond to the first package substrate 110a, the second control circuit elements 115a, and the second molding part 140a in the first control circuit module package 100a of FIG. 8, respectively, and the descriptions thereof may be referred to each other.

The second control circuit elements 115b may be mounted on the second package substrate 110b and used for controlling the operations of the electronic cigarette and/or controlling the charging of the battery inside the electronic cigarette. For example, the second control circuit elements 115b may include a plurality of active elements 120b and a plurality of passive elements 130b.

The second molding part 140b may integrally encapsulate the second control circuit elements 115b. For example, the active elements 120b and the passive elements 130b constituting the second control circuit elements 115b may be integrally encapsulated.

FIG. 11 is a cross-sectional view schematically showing a modified example 100b1 of the second control circuit module package 100b of FIG. 10. The second control circuit module package 100b1 is a partially modified one of the second control circuit module package 100b, and thus the same description as in the embodiments will be omitted.

Referring to FIG. 11, at least some of the second control circuit elements 115b may be mounted on the second package substrate 110b in a state in which they are separately molded in advance.

For example, at least one of the active elements 120b may be mounted on the second package substrate 110b in a state in which they are separately molded in advance, and most of the other active elements 120b1 may be mounted on the second package substrate 110b in an unpackaged state, for example, at the wafer die level.

The second molding part 140b may integrally encapsulate some of the second control circuit elements 115b, for example, the active elements 120b, and the passive elements 130b may be exposed from the second molding part 140b. Additionally, a height of the second molding part 140b may vary in accordance with heights of the second control circuit elements 115b.

The first control circuit module package 100a and/or the second control circuit module package 100b can be understood in more detail with reference to the description of the control circuit module package 100 of FIG. 1.

Meanwhile, the third control circuit module package 100c and the fourth control circuit module package 100d of FIG. 7 have different mounted elements from those of the first control circuit module package 100a or the second control circuit module package 100b described above, but can use the structure of the first control circuit module package 100a or the second control circuit module package 100b almost as it is.

For example, the third control circuit module package 100c may include a third package substrate, third control circuit elements, and a third molding part, and the fourth control circuit module package 100d may include a fourth package substrate, fourth control circuit elements, and a fourth molding part. The third package substrate and the fourth package substrate can be understood with reference to the description of the first package substrate 110a or the second package substrate 110b, and the third molding part can be understood with reference to the description of the first molding part 140a or the second molding part 140b.

In the control circuit module assembly 80, the first control circuit elements 115a in the first control circuit module package 100a and the second control circuit elements 115b in the second control circuit module package 100b may each include at least some of the control circuit elements 115 of FIG. 4.

For example, the first control circuit elements 115a may include elements for controlling the charging of the battery of the electronic cigarette 50 among the control circuit elements 115, and the second control circuit elements 115b may include elements for controlling the operations of the electronic cigarette 50 among the control circuit elements 115. More specifically, the first control circuit elements 115a may include the charging control circuit 128 and the battery protection circuit 129, and the second control circuit elements 115b may include two or more or all of the main control unit (MCU) 121, the heat generation control circuit 122, the motor control circuit 123, the sensor control circuit 124, the switch control circuit 125, the display device control circuit 126, and the Bluetooth control circuit 127.

Meanwhile, in the control circuit module assembly 80a of FIG. 7 described above, the first control circuit elements 115a in the first control circuit module package 100a, the second control circuit elements 115b in the second control circuit module package 100b, the third control circuit elements in the third control circuit module package 100c, and the fourth control circuit elements in the fourth control circuit module package 100d may each include at least some of the control circuit elements 115 of FIG. 4.

For example, the first control circuit elements 115a and the third control circuit elements may include elements for controlling the charging of the battery of the electronic cigarette 50 among the control circuit elements 115, and the second control circuit elements 115b and the fourth control circuit elements may include elements for controlling the operations of the electronic cigarette 50 among the control circuit elements 115.

More specifically, the first control circuit elements 115a and the third control circuit elements may separately include some of the charge control circuit 128 and the battery protection circuit 129, and the second control circuit elements 115b and the fourth control circuit elements may separately include some of the main control unit (MCU) 121, the heat generation control circuit 122, the motor control circuit 123, the sensor control circuit 124, the switch control circuit 125, the display device control circuit 126, and the Bluetooth control circuit 127.

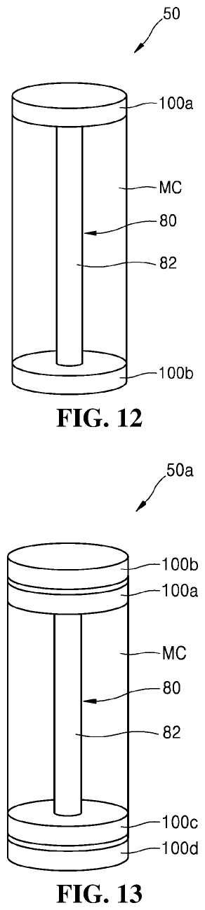

FIG. 12 is a perspective view schematically showing a configuration of the electronic cigarette 50 using the control circuit module assembly 80 of FIG. 6.

Referring to FIG. 12, the electronic cigarette 50 may include a main case MC and the control circuit module assembly 80 accommodated in the main case MC.

The main case MC is mainly a lower case in the electronic cigarette 50 and is a structure in which main components for operations and charging of the electronic cigarette 50 are accommodated. The electronic cigarette 50 may further include a cartridge or an atomizer coupled to an upper portion of the main case MC.

For example, the control circuit module assembly 80 may be accommodated in the main case MC such that the first control circuit module package 100a and the second control circuit module package 100b are disposed at both ends of the main case MC. Accordingly, a length of the connection line 82 may correspond to a length of the main case MC such that the first control circuit module package 100a and the second control circuit module package 100b are located at both ends of the main case MC.

According to such a structure of the electronic cigarette 50, since the first control circuit module package 100a and the second control circuit module package 100b are disposed at both ends of the main case MC, the utilization of an internal space of the main case MC can be greatly increased. Thus, even if a volume of the main case MC is reduced as a whole, it is possible to mount various components in the main case MC with ease.

FIG. 13 is a perspective view schematically showing a configuration of an electronic cigarette 50a using the control circuit module assembly 80a of FIG. 7. The electronic cigarette 50a is a modified one of the electronic cigarette 50 of FIG. 12, and thus the same description as in the embodiments will be omitted.

Referring to FIG. 13, the electronic cigarette 50a may include a main case MC and the control circuit module assembly 80a accommodated in the main case MC.

For example, the control circuit module assembly 80a may be accommodated in the main case MC such that the first control circuit module package 100a, the second control circuit module package 100b, the third control circuit module package 100c, and the fourth control circuit module package 100d are disposed at both ends of the main case MC. More specifically, the first control circuit module package 100a and the third control circuit module package 100c may be disposed in a stacked form at one end portion of the main case MC, and the second control circuit module package 100b and The fourth control circuit module package 100d may be disposed in a stacked form at the other end portion of the main case MC.

According to such a structure of the electronic cigarette 50a, the utilization of the internal space of the main case MC can be significantly increased as compared to conventional ones. Further, by separating the control circuit module assembly 80a into a multi-stage structure, a diameter of the main case MC can be reduced, and thus a diameter of the electronic cigarette 80a can be reduced to make the electronic cigarette 80a slimmer.

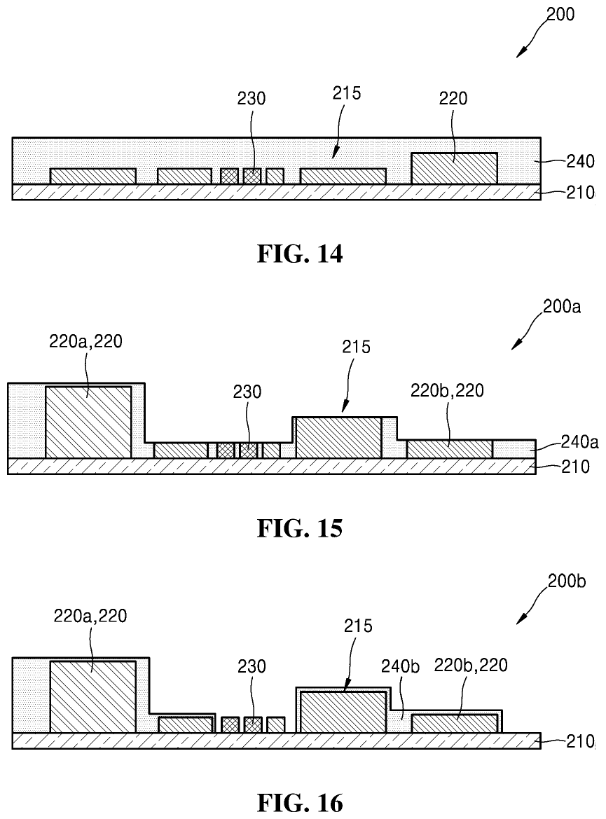

FIG. 14 is a cross-sectional view schematically showing a control circuit module package 200 for an electronic cigarette cradle according to an embodiment of the present invention.

Referring to FIG. 14, the control circuit module package 200 of an electronic cigarette cradle may include a package substrate 210, a plurality of control circuit elements 215, and a molding part 240.

The package substrate 210 may indicate a substrate for mounting and packaging components. The package substrate 210 may be understood with reference to the description of the package substrate 110 of FIG. 1.

The control circuit elements 215 may be mounted on the package substrate 210 and used to control charging of an electronic cigarette when the electronic cigarette is connected. For example, the control circuit elements 215 may include a plurality of active elements 220 and a plurality of passive elements 230. For example, some or all of the control circuit elements 215 may be mounted on the package substrate 210 using surface mounting technology (SMT).

The molding part 240 may integrally encapsulate the control circuit elements 215. For example, the active elements 220 and the passive elements 230 constituting the control circuit elements 215 may be integrally encapsulated. In this way, by integrally encapsulating the control circuit elements 215 with the molding part 240, a volume of the control circuit module package 200 can be greatly reduced as compared to the case of individually molding or packaging the control circuit elements 215.

Further, since the control circuit elements 215 are encapsulated by the molding part 240, the control circuit elements 215 can be effectively protected from moisture or the like around them. For example, in the case of a liquid electronic cigarette, the liquid flows into the control circuit elements 215 to cause problems such as corrosion or disconnection in many cases, but the occurrence of such a problem may be prevented by the molding part 240.

At least one of the control circuit elements 215 may be mounted on the package substrate 210 at the wafer die level and encapsulated by the molding part 240. The fact of being mounted on the package substrate 210 at the wafer die level may mean that an element is mounted on the package substrate 210 in a wafer die state without undergoing a separate molding or packaging process at the wafer die level.

Accordingly, since the element mounted at the wafer die level has a very thin thickness, a thickness of the molding part 240 can be made thinner, thereby contributing to reducing the volume of the control circuit module package 200 as a whole.

Further, some of the control circuit elements 215 may be mounted on the package substrate 210 in a stacked structure stacked at the wafer die level.

For example, after at least one of the active elements 220 is mounted on the package substrate 210 at the wafer die level, it may be encapsulated by the molding part 240. In some embodiments, by mounting all of the active elements 220 on the package substrate 210 at the wafer die level, the volume of the control circuit module package 200 can be reduced.

According to the control circuit module package 200 described above, the overall volume of the package can be reduced by integrally encapsulating at least some or all of the control circuit elements 215 with the molding part 240. Further, by mounting at least some of the control circuit elements 215 on the package substrate 210 at the wafer die level, the volume of the package can be further reduced.

In this way, when the volume of the control circuit module package 200 is reduced, a volume and a weight of the electronic cigarette cradle using the same can be reduced, so that the electronic cigarette cradle can be made smaller and lighter, and furthermore, the space utilization can be increased by securing the design margin. For example, by reducing the volume of the control circuit module package 200, a partial space thereof can be used to increase a battery capacity of the electronic cigarette cradle, and elements capable of implementing additional functions may be further added.

In addition, when a lead frame is used as the package substrate 210, it can function as a heat dissipating pad, thereby enhancing a heat dissipation effect, and further improving the charging efficiency of the battery.

Further, by encapsulating the control circuit elements 215 with the molding part 240, occurrence of a problem due to leakage or the like can be prevented, and thus the protection and reliability of the electronic cigarette cradle against the surrounding conditions can be improved.

FIG. 15 is a cross-sectional view schematically showing a control circuit module package 200a for an electronic cigarette cradle according to another embodiment of the present invention. The control circuit module package 200a according to this embodiment is a partially modified one of the control circuit module package 200 of FIG. 14, and thus the repeated description thereof will be omitted.

Referring to FIG. 15, at least some of the control circuit elements 215 may be mounted on the package substrate 210 in a state in which they are separately molded in advance.

For example, at least one active element 220a of the active elements 220 may be mounted on the package substrate 210 in a state in which it is separately molded in advance, and most of the other active elements 220b may be mounted on the package substrate 210 without being packaged, for example, at the wafer die level.

According to such a structure, the volume of the molding part 240 may be slightly increased due to a pre-molding volume of the active element 220a, but most of the active elements 220b are still mounted on the package substrate 210 without being molded, the volume of the control circuit module package 200a can be kept still smaller than conventional ones.

The molding part 240 may integrally encapsulate the control circuit elements 215, for example, the active elements 220 and the passive elements 230. Accordingly, both the active element 220a molded and mounted in advance and the active element 220b mounted at the wafer die level may be integrally encapsulated by the molding part 240.

Additionally, a height of the molding part 240 may vary in accordance with heights of the control circuit elements 215. In this case, by reducing the volume occupied by the molding part 240, the volume of the control circuit module package 200a can be further increased.

This structure can further increase the design margin of the electronic cigarette cradle using the control circuit module package 200a. For example, in the electronic cigarette cradle using the control circuit module package 200a, other components may be further disposed at a portion with a lower height of the molding part 240, thereby improving the space utilization.

FIG. 16 is a cross-sectional view schematically showing a control circuit module package 200b for an electronic cigarette cradle according to yet another embodiment of the present invention. The control circuit module package 200b according to this embodiment is a partially modified one of the control circuit module packages 200 and 200a of FIGS. 14 and 15, and thus the repeated description thereof will be omitted.

Referring to FIG. 16, in the control circuit module package 200b, some or all of the passive elements 230 may be exposed from the molding part 240. In the case of the passive elements 230, they have simple structures and there is a relatively low possibility of a problem occurring even if there is moisture around them due to leakage or the like as compared to the active elements 220, and thus some or all of the passive elements 230 can also be exposed from the molding part 240.

However, even in this case, the control circuit elements 215 other than the exposed passive elements 230 may be integrally encapsulated by the molding part 240.

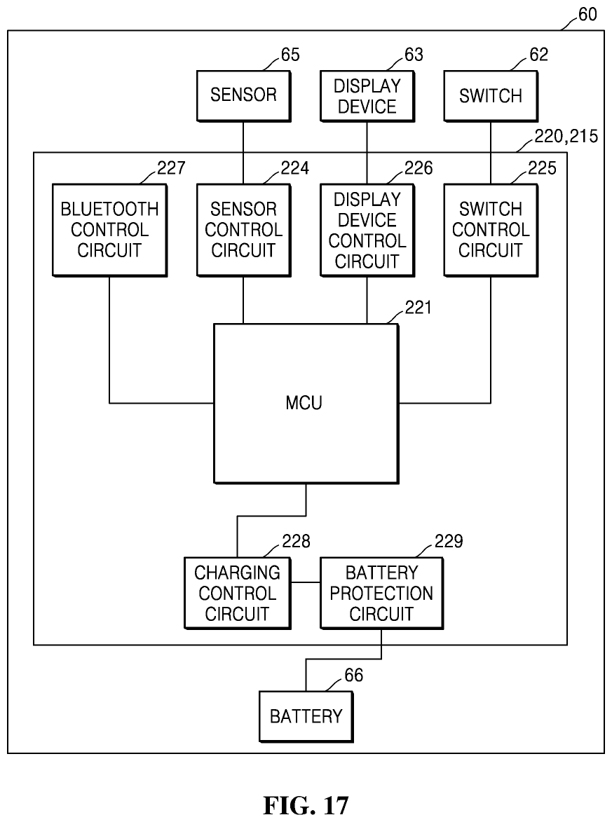

FIG. 17 is a block diagram showing a configuration of the control circuit elements 215 in the control circuit module package and a configuration of an electronic cigarette cradle 60 including the same according to embodiments of the present invention.

Referring to FIG. 17, the electronic cigarette cradle 60 may include the control circuit elements 215, at least one switch 62, at least one display device 63, at least one sensor 65, and at least one battery 66.

In FIG. 17, the active elements 220 are shown as main components of the control circuit elements 215, and the passive elements 230 are omitted.

The active elements 220 may include at least two or more or all of a main control unit (MCU) 221, at least one sensor control circuit 224, at least one switch control circuit 225, at least one display device control circuit 226, at least one Bluetooth control circuit 227, at least one charging control circuit 228, and at least one battery protection circuit 229

The main control unit 221 may be a central processing unit that controls major operations of the electronic cigarette cradle 60. For example, the main control unit 221 may receive signals from the switch 62 and the sensor 65, control charging of a battery 66 in the electronic cigarette cradle 60, and control charging of an electronic cigarette when the electronic cigarette is connected to the electronic cigarette cradle 60.

The sensor control circuit 224 may be connected between the main control unit 212 and the sensor 65, the switch control circuit 225 may be connected between the main control unit 221 and the switch 62, and the display device control circuit 126 may be connected between the main control unit 221 and the display device 63. The Bluetooth control circuit 227 may be connected to the main control unit 221 to control a Bluetooth signal.

The charging control circuit 228 and the battery protection circuit 229 may be connected between the main control unit 221 and the battery 66 to control the charging of the battery 66, and control operations of the battery 66 to protect the battery 66 in situations such as overcharging, overvoltage, and overcurrent of the battery 66. For example, the battery protection circuit 229 may include a protection integrated circuit and a field effect transistor.

In the control circuit module packages 200, 200a, and 200b described above, the active elements 220 may include a plurality of control circuits as described above, and these control circuits may be mounted on the package substrate 210 at the wafer die level and integrally encapsulated by the molding part 240.

Although the present invention has been described with reference to the embodiments illustrated in the drawings, these are merely exemplary and those having ordinary knowledge in the art will understand that various modifications and equivalent other embodiments are possible therefrom. Therefore, the genuine technical scope of the present invention should be determined by the technical spirit of the appended claims.

What is claimed is:

1. A control circuit module package of an electronic cigarette comprising:
a package substrate;
a plurality of control circuit elements mounted on the package substrate for controlling operations of the electronic cigarette and controlling charging of a battery inside the electronic cigarette; and
a molding part that integrally encapsulates the plurality of control circuit elements.

2. The control circuit module package of an electronic cigarette according to claim 1,
wherein the plurality of control circuit elements include a plurality of active elements, and
the plurality of active elements are integrally encapsulated on the package substrate by the molding part.

3. The control circuit module package of an electronic cigarette according to claim 2,
wherein the plurality of control circuit elements further include a plurality of passive elements, and
the plurality of active elements and the plurality of passive elements are integrally encapsulated on the package substrate by the molding part.

4. The control circuit module package of an electronic cigarette according to claim 2, wherein at least one element of the plurality of control circuit elements is mounted on the package substrate at a wafer die level and encapsulated by the molding part.

5. The control circuit module package of an electronic cigarette according to claim 4, wherein all of the plurality of active elements are mounted on the package substrate at the wafer die level and encapsulated by the molding part.

6. The control circuit module package of an electronic cigarette according to claim 4, wherein at least another one of the plurality of active elements is mounted on the package substrate in a state in which it is separately molded in advance.

7. The control circuit module package of an electronic cigarette according to claim 2,
wherein the plurality of control circuit elements further include a plurality of passive elements, and
the plurality of passive elements are exposed from the molding part.

8. The control circuit module package of an electronic cigarette according to claim 2, wherein the plurality of active elements include at least two or more of a main control unit, at least one heat generation control circuit, at least one motor control circuit, at least one sensor control circuit, at least one switch control circuit, at least one display device control circuit, at least one Bluetooth control circuit, at least one charging control circuit, and at least one battery protection circuit.

9. The control circuit module package of an electronic cigarette according to claim 2, wherein the plurality of active elements include all of a main control unit, at least one heat generation control circuit, at least one motor control circuit, at least one sensor control circuit, at least one switch control circuit, at least one display device control circuit, at least one Bluetooth control circuit, at least one charging control circuit, and at least one battery protection circuit.

10. The control circuit module package of an electronic cigarette according to claim 1, wherein a height of the molding part varies in accordance with heights of the plurality of control circuit elements.

11. The control circuit module package of an electronic cigarette according to claim 1, wherein the package substrate includes any one of a printed circuit board and a lead frame, or a stacked structure thereof.

12. The control circuit module package of an electronic cigarette according to claim 1, further comprising a heat generation device connected to one end of the package substrate.

13. A control circuit module assembly of an electronic cigarette comprising:
a first control circuit module package of the electronic cigarette;
a second control circuit module package of the electronic cigarette; and
a connection line that electrically connects the first control circuit module package with the second control circuit module package,
wherein the first control circuit module package includes first control circuit elements among a plurality of control circuit elements for controlling operations of the electronic cigarette and controlling charging of a battery, and
the second control circuit module package includes second control circuit elements among the plurality of control circuit elements for controlling the operations of the electronic cigarette and controlling the charging of the battery.

14. The control circuit module assembly of an electronic cigarette according to claim 13,
wherein the first control circuit elements include elements for controlling the charging of the battery of the electronic cigarette among the plurality of control circuit elements, and
the second control circuit elements include elements for controlling the operations of the electronic cigarette among the plurality of control circuit elements.

15. The control circuit module assembly of an electronic cigarette according to claim 13,
wherein the connection line includes a flexible printed circuit board (FPCB), and
a length of the connection line corresponds to a length of a main case so that the first control circuit module package and the second control circuit module package are respectively located at both ends of the main case when they are accommodated in the main case of the electronic cigarette.

16. The control circuit module assembly of an electronic cigarette according to claim 13, further comprising:
a third control circuit module package of the electronic cigarette connected to the first control circuit module package, and
a fourth control circuit module package of the electronic cigarette connected to the second control circuit module package,
wherein the third control circuit module package includes third control circuit elements among the plurality of control circuit elements for controlling the operations of the electronic cigarette and controlling the charging of the battery, and
the fourth control circuit module package includes fourth control circuit elements among the plurality of control circuit elements for controlling the operations of the electronic cigarette and controlling the charging of the battery.

17. A control circuit module package for an electronic cigarette cradle comprising:
a package substrate;
a plurality of control circuit elements mounted on the package substrate for controlling charging of the electronic cigarette when the electronic cigarette is connected; and
a molding part that integrally encapsulates the plurality of control circuit elements.

18. The control circuit module package for an electronic cigarette cradle according to claim 17,
wherein the plurality of control circuit elements include a plurality of active elements, and
the plurality of active elements are integrally encapsulated on the package substrate by the molding part.

19. The control circuit module package for an electronic cigarette cradle according to claim 17, wherein at least one element of the plurality of control circuit elements is mounted on the package substrate at a wafer die level and encapsulated by the molding part.

20. The control circuit module package for an electronic cigarette cradle according to claim 17, wherein a height of the molding part varies in accordance with heights of the plurality of control circuit elements.
